(19) United States
(12) Patent Application Publication
(10) Pub. No.: US 2025/0350947 A1
(43) Pub. Date: Nov. 13, 2025

(54) UE COMPLIANCE BASED FEATURE ENABLEMENT

(71) Applicant: InterDigital Patent Holdings, Inc., Wilmington, DE (US)

(72) Inventors: Michael Starsinic, Newtown, PA (US); Ulises Olvera-Hernandez, Saint-Lazare (CA); Milind Kulkarni, Hawthorn Woods, IL (US); Sebastian Robitzsch, London (GB); Rocco Di Girolamo, Laval (CA); Saad Ahmad, Montreal (CA)

(73) Assignee: InterDigital Patent Holdings, Inc., Wilmington, DE (US)

(21) Appl. No.: 18/657,337

(22) Filed: May 7, 2024

(51) Int. Cl. H04W 12/106; H04W 12/069; H04W 60/04

(52) U.S. Cl. CPC H04W 12/106; H04W 12/069; H04W 60/04

(57) ABSTRACT

Methods and devices are disclosed for validating that a WTRU supports the use of network system features. In one example an AMF receives, from a WTRU, a registration request message indicating the WTRU intends to use a system feature of the network. The AMF sends a registration accept message to the WTRU indicating the system feature is supported by the network and the WTRU may use the feature on a condition the network validates the WTRU supports the system feature. A system feature validation trigger is sent for the WTRU to perform a system feature validation procedure with a user equipment certification validation (UCV) Server. The AMF receives, from the UCV Server, a validation result of the procedure indicating the WTRU is validated or not validated to use the system feature. The AMF sends the WTRU, a configuration update message based on the received validation result message.

### BACKGROUND

In the fifth generation (5G) system (5GS), it is mandatory that a user equipment (UE) support certain features. For example, it is mandatory that the UE support non-access stratum (NAS) mobility management signaling. Since this and other features are mandatory, the UE does not indicate to the network whether the UE support the features as the network assumes that the UE supports mandatory features.

Other network features are optional for the UE to support in the 5GS. For example, features such as receiving network slice simultaneous usage group (NSSRG) information is optional for the UE to support. Since these features are optional, the UE indicates to the network whether the UE support the features. For example, the UE can indicate support for receiving NSSRG information during a registration procedure by setting a bit in the 5G mobility management (5GMM) capability information element. Thus, the network (i.e. 5G core network (5GC)) is able to know whether the UE might attempt to activate, or use, an optional feature.

It has been found that some UEs do not support mandatory features. A UE that does not support a mandatory feature may behave in unexpected ways when communicating with the network and thus trigger unexpected network behavior. Similarly, a UE may indicate to the network that it supports certain optional features, when actually the UE might not fully support the optional feature or might not have passed all conformance tests that are associated with the optional feature. A similar situation may also exist for mandatory features in that a UE may support some functionality that is associated with mandatory features, but the UE may not have passed all conformance tests that are associated with the mandatory features.

Currently, there are no mechanisms in the 5GS for the 5GC to detect whether a UE is a non-compliant UE. A non-compliant UE is one that does not fully support a mandatory feature or a UE that indicates that it supports an optional feature but does not fully support the optional feature. A UE may be non-compliant UE because the UE was not properly tested or was incorrectly designed. System enhancements are desired to allow the network (i.e. the 5GC) to reliably detect whether a UE supports a feature and then to selectively enable and/or disable features based on the detected level of support.

### SUMMARY

According to various aspects, devices and methods are disclosed for network validation of UE compliance to support a system feature. As described herein, a UE may alternatively be referred to as a wireless transmit receive unit (WTRU).

In one aspect, network validation of WTRU compliance may be performed by an access and mobility management function (AMF). An AMF may perform the following actions:

First, the AMF receives a registration request message from a WTRU. The registration request message indicates that the WTRU wants to use a system feature of the network. Next, the AMF sends a registration response message to the WTRU. The registration response message indicates that the system feature is supported by the network and indicates that the system feature can only be used by the WTRU after the network validates the WTRU supports the system feature. The registration response may also indicate that that the network has not yet validated that the WTRU supports the system feature and/or the validation is pending.

The AMF sends a trigger, in the registration response message, or a subsequent trigger message, to the WTRU to initiate a procedure to validate the WTRU's support of the requested system feature. In one example, this trigger message may be a DL NAS Transport Message that carries an extensible authentication protocol (EAP) Identity Request. The trigger message may also indicate which system feature(s) the WTRU is expected to validate. In another example, the trigger message may be a DL NAS Transport Message that carries an identity of a user equipment certification validation (UCV) Server and a general public subscription identifier (GPSI) of the WTRU. The trigger message may also indicate which features the WTRU is expected to verify.

The AMF next receives a message that indicates the results of the validation procedure whether the WTRU's support of the system feature has been validated. In one example, this message may be received from a unified data management (UDM)/unified data repository (UDR). In another example, this message may be received from the UCV Server.

The AMF sends a WTRU Configuration Update message to the WTRU. If the result of the validation procedure was that the WTRU's support of the system feature was validated, then the WTRU Configuration Update message indicates to the WTRU that the WTRU may use the system feature. If the result of the validation procedure was that the WTRU's support of the system feature was not validated, then the WTRU Configuration Update message indicates to the WTRU that the WTRU may not use the system feature.

In other aspects, network validation of WTRU compliance may be performed by a WTRU. A WTRU may perform the following actions.

First the WTRU sends a registration request message to the network that indicates the WTRU wants to use the system feature. Next, the WTRU receives a registration response message from the network. The registration response message indicates that the requested system feature is supported by the network but that the system feature can only be used by the WTRU after the network validates the WTRU supports the system feature. The registration response may also indicate that that the network has not yet validated that the WTRU supports the system feature.

The WTRU receives from the network, in the registration response or a subsequent message, a trigger to initiate a procedure to validate the WTRU's support of the system feature. In one example, this trigger message may be a DL NAS Transport Message that carries an EAP Identity Request. The message may also indicate which feature(s) the WTRU is expected to verify. The procedure to validate the WTRU's support of the system feature is based on the EAP protocol and the WTRU sends and receives EAP messages in NAS messages to perform the validation procedure.

In another example, the trigger message may be a DL NAS Transport Message that carries an identity of a UCV Server and GPSI of the WTRU. The trigger message may also indicate which features the WTRU is expected to verify. In this example, the procedure to validate the WTRU's support of the system feature is based on an Application Layer protocol. A WTRU application performs the system feature validation procedure with a UCV Server based on the identity of the UCV Server in the trigger message from the network.

The WTRU receives a WTRU Configuration Update message from the network that indicates to the WTRU whether the WTRU may use the system feature. Lastly, if the WTRU Configuration Update message indicates to the WTRU that the WTRU may use the system feature, the WTRU begins to use, or activates, the validated system feature. Additional aspects, features and advantages may be apparent from the embodiments described below.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a network diagram showing an example WTRU certification procedure;

FIG. 3 is a network diagram illustrating an example method for detecting that a system feature requires validation according to various embodiments;

FIG. 4 is network diagram illustrating an example method for feature validation using an extensible authentication procedure (EAP) according to one embodiment;

FIG. 5 is a network diagram illustrating an example method for feature validation in an application layer according to another embodiment;

FIG. 6 is a flow diagram illustrating an example method for system feature validation by an access and mobility management function (AMF) according to various embodiments;

FIG. 7 is a flow diagram illustrating an example method for system feature validation by a wireless transmit receive unit (WTRU) according to various embodiments;

FIG. 8 is a network diagram illustrating an example method for handling a WTRU's support for session management features according to an embodiment; and

FIG. 9 is a network diagram illustrating an example method for an AMF accounting for a WTRU's support of system features according to an embodiment.

### DETAILED DESCRIPTION

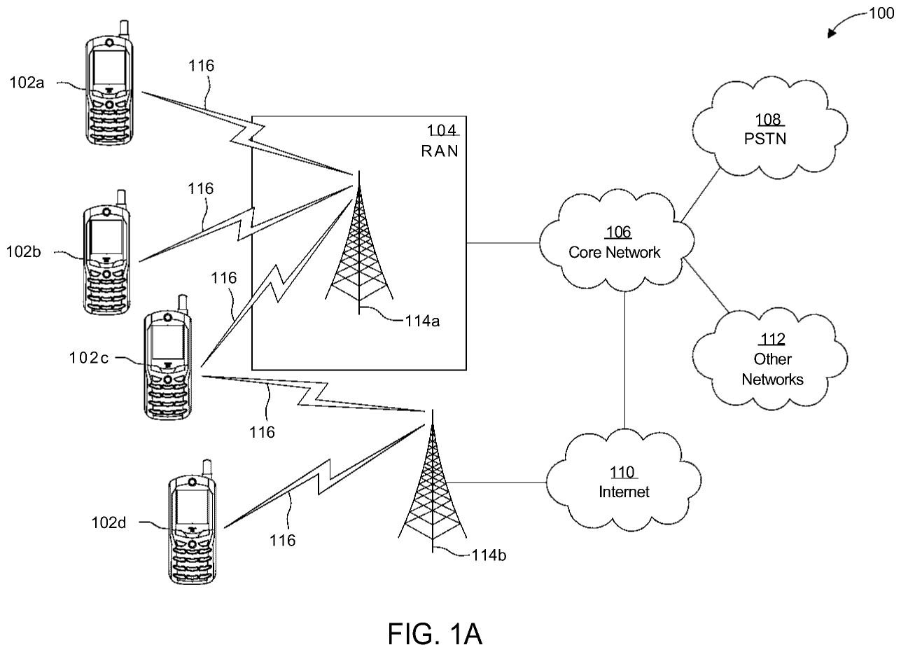

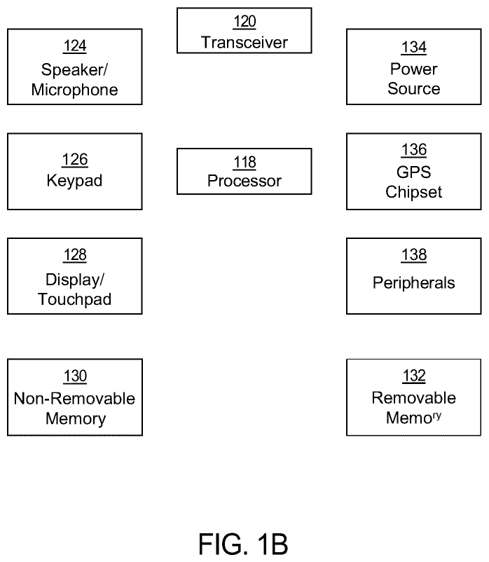

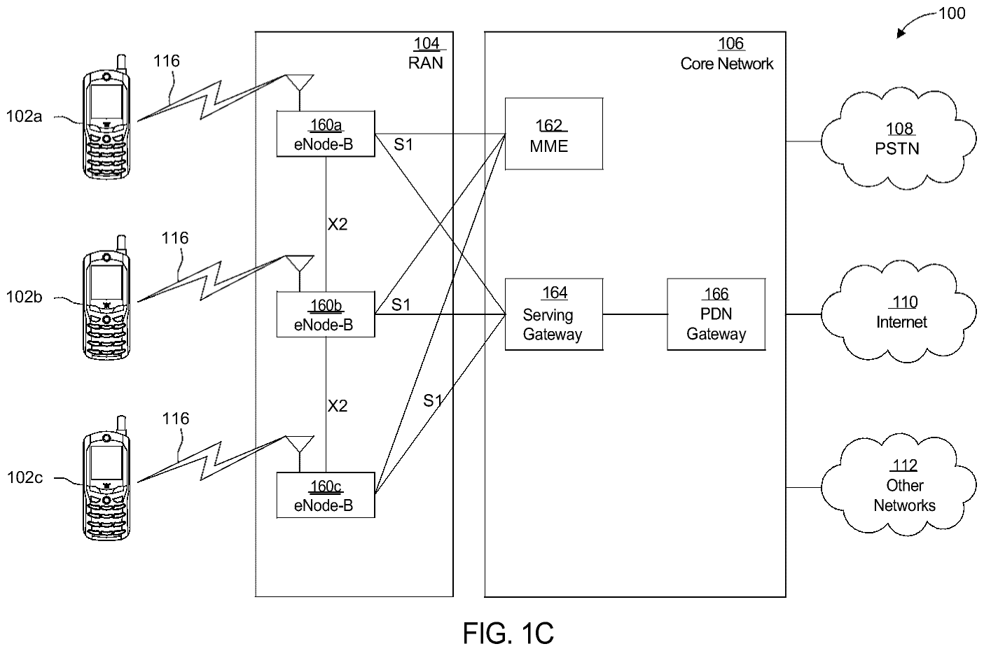

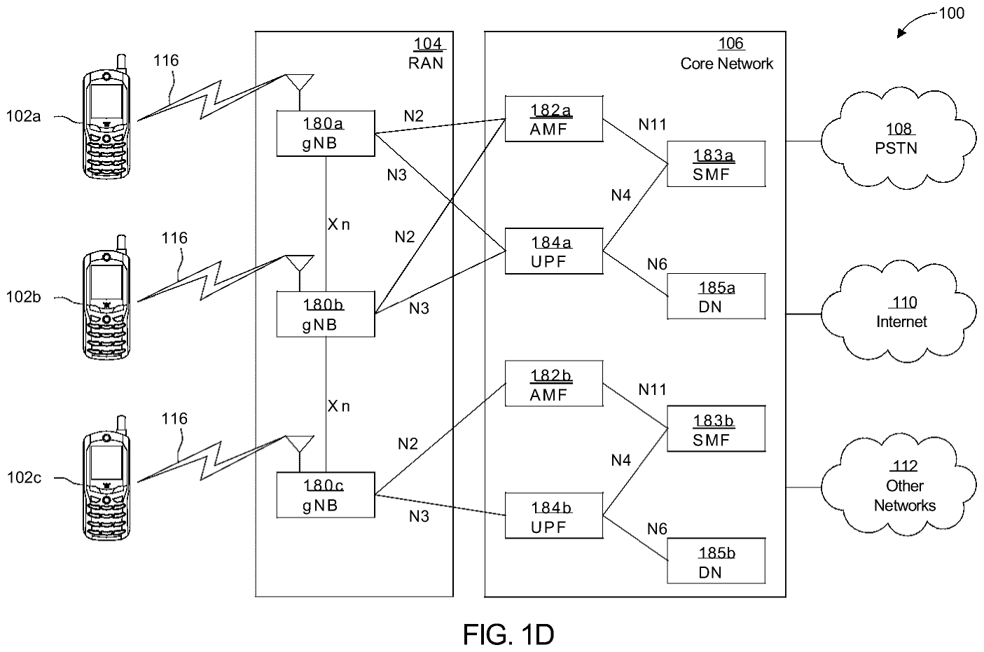

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

As previously discussed, in the 5G System (5GS), it is mandatory that the WTRU support certain features. For example, it is mandatory that the WTRU support NAS mobility management. Since this and other features are mandatory, the WTRU does not indicate to the network whether the WTRU support the features as the network presumes that the WTRU supports the mandatory features.

Other features are optional in the for the WTRU to support in the 5GS. For example, features such as receiving NSSRG information is optional for the WTRU to support. Since this, or other features are optional, the WTRU indicates to the network whether the WTRU support the features. For example, the WTRU can indicate support for receiving NSSRG information during registration procedure by setting a bit in the 5GMM Capability information element. Thus, the network (i.e. 5G core (5GC) is able to know whether the WTRU might attempt to activate, or use, an optional feature.

It has been observed that some WTRUs do not support mandatory features. A WTRU that does not support a mandatory feature may behave in unexpected ways when communicating the network and thus trigger unexpected network behavior. Similarly, a WTRU may indicate to the network that it supports certain optional features, but the WTRU might not fully support the optional feature or might not have passed all conformance tests that are associated with the optional feature, which may cause issues. Similarly, a WTRU may support some functionality that is associated with a mandatory feature, but the WTRU may also not have passed all conformance tests that are associated with the mandatory feature. Presently, there are no mechanisms in the 5G System for the 5GC to detect whether a WTRU is a non-compliant WTRU. A non-compliant WTRU is a WTRU that does not fully support a mandatory feature or a WTRU that indicates that it supports an optional feature but does not fully support the optional feature. A WTRU may be non-compliant WTRU because the WTRU was not properly tested or incorrectly designed.

System enhancements are desired to allow the network (i.e. the 5GC) to reliably detect whether the WTRU supports a feature and then to selectively enable and disable features based on the detected level of support. It has been proposed that a user equipment certification validation (UCV) Server may store UE/WTRU certification information. WTRU Certification Information may be any information that can help to identify what certifications have been received by a WTRU. It has further been proposed that a network may include a UCV Function that is used to route traffic to a UCV Server.

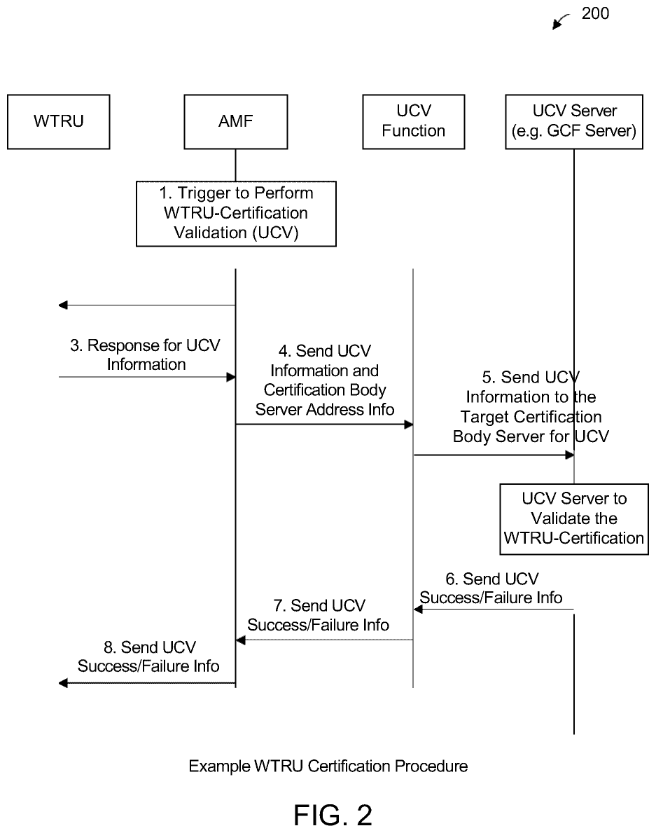

Referring to FIG. 2, an example procedure 200 is described for one proposal how the 5GC (i.e. based on the AMF) could potentially interact with the UCV Server. In the example of FIG. 2, the AMF is triggered to check the WTRU's UCV Information in step 1. In step 2, the AMF sends a request to the WTRU for the UCV Information. In step 3, the WTRU sends the UCV Information to the AMF. In step 4, the UCV Information to the UCV Function. In step 5, the UCF Function forwards the UCV Information to the UCV Server. In step 6, the UCF Server determines if the UCF Information is valid and sends a success or failure indicate to the UCV Function. In step 7, the UCV Function sends the success or failure indicate to the AMF. In step 8, the AMF sends the success or failure indicate to the WTRU. The example procedure 200 does not explain how to handle scenarios where the WTRU has registered to the network but the network has not yet verified the WTRU supports certain features. Furthermore, the example procedure 200 does not explain how to handle scenarios where the WTRU should be permitted to access some features because the network was able to verify that the WTRU supports the features, but the WTRU should also not be permitted to access other features because the network was not able to verify that the WTRU supports the other features.

Embodiments described herein detail solutions that enable the network to check, verify or confirm, that a WTRU properly supports a system feature before the network grants the WTRU permission to use the system feature. In other words, the solutions enable the network to verify that the WTRU has properly implemented the system feature. One feature of the disclosed embodiments is that, when a WTRU requests to use a system feature, the network indicates that the WTRU cannot use the feature until the network verifies that the WTRU supports the feature. In various embodiments, the network triggers a procedure to verify that the WTRU supports the system feature. In some examples, when the procedure complete, the network receives an indication of the WTRU support/compliance/certification of support from a verification entity, e.g., a 3rd party verification server. This indication informs the network whether the WTRU supports the system feature or not. The network then sends an update message to the WTRU so that the WTRU knows that the feature is now available to the WTRU. Later, when the WTRU attempts to perform operations within a network slice (e.g. within a PDU Session), network nodes that are not dedicated to specific network slices (e.g. the AMF and UDM/UDR) can configure the network nodes that are slice specific with information about what system features the WTRU is permitted to use. The network nodes that are slice specific can then use the information to determine how to respond to requests from the WTRU.

Embodiments disclosed herein relate to validating that a WTRU supports a system feature. As used herein, validating that the WTRU supports a system feature may mean that a network node receives an indication from another entity or network function (i.e. not from the WTRU) that confirms that the WTRU supports the system feature. For example, the indication may come from a UCV Server, from the WTRU's subscription information in the unified data management (UDM)/unified data repository (UDR), or from the WTRU's context information stored by a network function (NF). The indication means that it has been previously verified that the WTRU, or all WTRU's of the same WTRU type (e.g., manufacturer and model), support the network feature and are likely to properly execute any procedures that are associated with using the system feature. According to various embodiments a WTRU is not permitted, by the network, to access, or activate, a system feature unless and until the WTRU's support for the feature has been verified/validated.

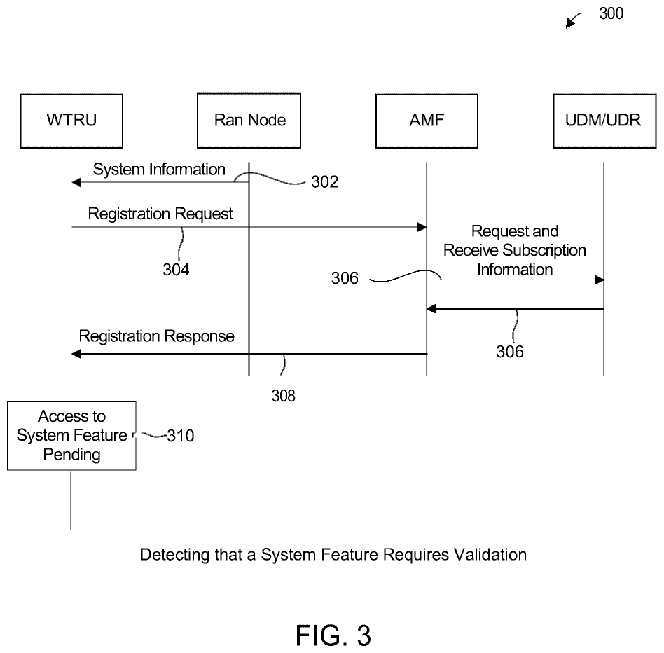

Embodiments for detecting that a system feature support for a WTRU requires validation are now described. Referring to FIG. 3, an example method 300 is shown for how a WTRU may detect that a network supports a system feature, but that the WTRU is not permitted to use the system feature until the network validates that the WTRU supports the system feature. It is noted that method 300 is only an illustrative example, as are other methods described herein, and steps shown may be altered, combined within the method embodiment, combined with other method embodiments, omitted and/or performed in different sequences, while remaining within the scope of the solution embodiments.

In method 300 of FIG. 3, a radio access network (RAN) node (e.g., a base station) may broadcast 302 system information in, for example, a system information block (SIB). The system information may indicate one or more system features that are supported by the network. In certain examples, the system information also indicates that, before the WTRU can use a specific system feature, the WTRU needs to perform a procedure with the network in order to validate that the WTRU supports the system feature. In some embodiments, this information may alternatively be provided to a WTRU in other manners, such as by radio resource control (RRC) configuration or dynamically, e.g., upon request of the WTRU.

Next, the WTRU may determine it intends or desires to use a system feature requiring validation and sends 304 a Registration Request to the network, e.g., the access and mobility management function (AMF). The WTRU may determine to send the Registration Request because it wants to use a system feature that requires validation. In other words, the WTRU needs to use the system feature and selects to send the Registration Request to this RAN Node instead of another RAN Node because the RAN Node indicates that the network supports the desired system feature. In one example, the WTRU indicates, in the Registration Request, that the WTRU wants to use the system feature and that the WTRU supports a procedure validating that the WTRU supports the system feature.

Upon reception of the Registration Request the AMF is triggered to send 306 a request to the unified data management (UDM)/unified data repository (UDR) for the WTRU's subscription information and receive a 306 response from the UDM/UDR with the WTRU's subscription information. Alternatively, or in addition, the AMF could send the request to, and receive the response from, the AMF that last served the WTRU.

Next, the AMF sends 308 a Registration Response to the WTRU. The Registration Response may indicate that the system feature is supported by the network and/or indicate that the system feature can only be used by the WTRU after the network validates that the WTRU supports the system feature. In one example, the Registration Response may indicate that that the network has not yet validated that the WTRU supports the system feature.

In certain cases, the AMF may indicate that that the network has already validated the WTRU supports the feature. For example, the WTRU's subscription information from the UDM/UDR or context information from another AMF may indicate that the WTRU's support for the system feature has already been validated.

According to some embodiments, the Registration Response may also indicate one or more other system features that are supported by the network but not yet requested by the WTRU. The Registration Response may also indicate if the network needs to validate whether the WTRU supports each system feature before the system feature is used by the WTRU. The WTRU may use this information later, if the WTRU determines that it wants to use one of the other system features. In other words, the WTRU can use the information to determine whether to request the system feature in a future Registration Procedure (e.g., a Registration Update procedure).

At step 310, the WTRU may consider that access to the system feature is pending validation. When a system feature is pending validation, the WTRU may not attempt to use, request, or activate the system procedure until the system feature is validated. The Registration Response may inform the WTRU to wait for the network to trigger a validation procedure or that the WTRU should trigger the validation procedure.

FIG. 3 method 300 illustrates an example of how the WTRU can detect that the network supports a single system feature. It should be appreciated that the same procedure can be used by the WTRU to detect that the network supports multiple system features and used by the network to indicate to the WTRU that the WTRU's support for multiple system features needs to be validated. For example, the system information of step 302 can indicate multiple system features, the Registration Request of step 304 can indicate multiple system features, and the Registration Response of step 308 may be updated to indicate that multiple system features require validation and/or certain of the system features are already validated by the network for use by the WTRU. Furthermore, it should be appreciated that the same procedure can be used by the WTRU to validate that the WTRU supports certain system features in combination with other features. In combination with other features means that the WTRU may use more than one system feature at the same time. The procedure may also be used by the network to control which system features the WTRU is permitted to use at the same time.

Embodiments for System Feature Validation via extensible authentication protocol (EAP) are now described.

The Registration Response sent in step 308 of FIG. 3 may trigger the AMF to initiate a procedure that validates the WTRU's support for the system feature, referred to as a feature validation procedure or method. In other words, sending a Registration Response that indicates that the WTRU may only use the system feature on condition that the WTRU's support for the system feature is validated, may trigger the AMF to initiate a procedure that validates the WTRU's support for the system feature.

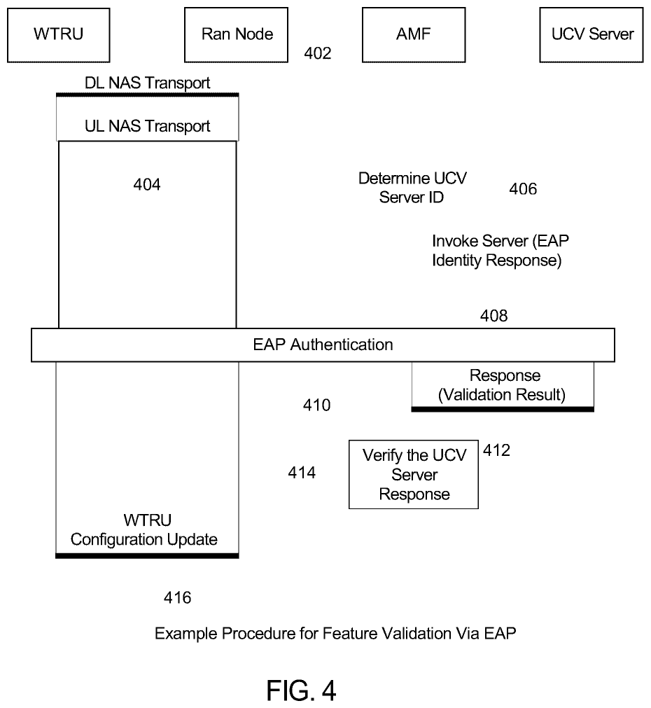

Referring to FIG. 4, an example feature validation method 400 using an EAP based validation procedure is shown. Method 400 may begin with the AMF sending 402 a message, e.g., in a downlink (DL) non-access stratum (NAS) Transport Message, to the WTRU to trigger system feature validation by the WTRU. This message may generally be referred to as a system feature validation trigger or validation trigger message, which includes information for the WTRU to perform a system feature validation procedure. In the example embodiment shown in FIG. 4, a DL NAS Transport Message includes an EAP Identity Request and an indication that the request is for system feature support verification/validation. The message may optionally indicate which system feature(s) the WTRU is expected to verify/validate.

In this embodiment, the WTRU responds to the system feature validation trigger message from the AMF by sending 404 a message for system feature validation, e.g., an uplink (UL) NAS Transport Message, to the AMF. This message may generally be referred to as a system feature validation message. In this example, the UL NAS Transport Message includes an EAP Identity Response, an indication that the purpose of the UL NAS Transport Message and EAP Identity Response is to validate support of one or more system features, and an identity of a user equipment certification validation (UCV) Server. The identity of the UCV Server may be a fully qualified domain name (FQDN) or an IP Address.

If the DL NAS Transport message of step 402 indicated which system feature the WTRU is expected to verify, then the WTRU may use the indication of system feature provided to determine which UCV Server address to include in the UL NAS Transport Message. In some embodiments, the WTRU may include multiple UCV Server identities in the UL NAS Transport Message so that the AMF can select which UCV Server is used to validate the WTRU's support of the system feature. For example, the network may prefer to use certain 3rd parties for validation instead of other 3rd parties. In step 406, if necessary, the AMF may determine the UCV Server identify to send the EAP Identity Response.

In one example, the AMF may select a UCV Server from one or more UCV Server identities that are included in the UL NAS Transport message from the WTRU. For example, the AMF may be configured with policies that indicate a how to prioritize UCV Servers and may select the UCV Server identity (ID) that is included in the UL NAS Transport with a higher in priority than any other UCV Server identities that are included in the UL NAS Transport message.

In another example, the AMF may select the UCV Server based on a UCV Server identifier that was included in the WTRU's subscription information and received from the UDM/UDR.

In a further example, the AMF may select the UCV Server based on a UCV Server identifier that was included in the WTRU's context information and received from another NF (e.g. another AMF).

According to yet a further example, the AMF may select the UCV Server based on the permanent equipment identifier (PEI) of the WTRU. The PEI may have been received from the WTRU, obtained from the WTRU's subscription, or obtained from another NF (e.g. in context information from another NF). For example, the AMF may use the type allocation code (TAC) field of the PEC to determine the UCV Server since the TAC field is indicative of the manufacturer and model number of the WTRU.

In step 408, the AMF forwards the EAP Identity Response to the UCV Server that was determined in step 406. When the AMF sends the EAP Identity Response to the UCV Server, the AMF may also send the following information to the UCV Server: (i) a transaction identifier; and/or (ii) an indication of one or more system features that need to be validated.

Next, the AMF and UCV Server perform 410 an EAP Authentication procedure. As mentioned, the identity in the EAP Identity Response in step 408 may be a PEI of the WTRU.

If the UCV Server recognizes the identity of the WTRU and the UCV Server has configuration data that indicates that the WTRU does not support any of the one or more system features that need to be validated, then step 410 may be skipped and no EAP Authentication procedure needs to be performed.

If the UCV Server recognizes the identity of the WTRU and the UCV Server has configuration data that indicates that the WTRU does support any of the one or more system features that need to be validated, then the EAP Authentication procedure of step 410 will be performed. In the EAP Authentication procedure 410, the UCV Server authenticates the identity that was provided in the EAP Identity Response. The UCV Server may have information stored that indicates which system features can be validated for the identity. In one example, the WTRU may send a subscription identifier (e.g. subscription permanent identifier (SUPI) or general public subscription identifier (GPSI) to the UCV Server during the EAP Authentication procedure.

In step 412, the UCV Server sends a response with a validation result to the AMF. In various embodiments the response includes one or more of the following information: (i) the transaction identifier that was provided in step 408, which is used by the AMF to correlate the UCV Server request of step 408 with the response from the UCV Server of step 412; (ii) the identity that was received in the EAP Identity Response (e.g., the PEI) or, if the UCV Server receives a subscription identifier in the EAP authentication procedure of step 410, a subscription identifier of the WTRU; and (iii) an indication of whether each of the one or more system features that were indicated in step 408 were validated.

The response from the UCV Server in step 412 may indicate that the UCV Server, or another service provider, is willing to sponsor the WTRU's use of the system feature and the AMF may store this sponsorship indication in a charging data record (CDR).

In step 414, the AMF may verify the response from the UCV Server. In one example, verifying the response from the UCV Server may mean that the AMF checks that the subscription identifier that was provided in step 412 is the same subscription identifier that is associated with the UL NAS Message from the WTRU of step 404. In one example, verifying the response from the UCV Server may mean that AMF checks that the PEI that was provided from the UCV Server in step 412 is associated with the subscription identifier that is associated with the UL NAS Message from the WTRU of step 404.

Lastly, the AMF may send 416 a WTRU Configuration Update message to the WTRU based on the validation result from the UCV Server in step 412. If the message from the UCV Server indicated the system feature was validated, then the WTRU Configuration Update message 416 indicates that the system feature was validated. The indication that the system feature was validated indicates to the WTRU that the system feature can be used by the WTRU. In some embodiments, the AMF may store information in the WTRU's context and/or subscription information that the system feature was validated.

If the message from the UCV Server in step 412 indicated the system feature was NOT validated for the WTRU, then the WTRU Configuration Update message indicates that the system feature was NOT validated. The indication that the system feature was NOT validated indicates to the WTRU that the system feature cannot be used by the WTRU.

In one example, if the AMF could not determine a UCV Server identity in step 406 or if no response was received from the UCV Server (i.e., no validation result is provided at step 412), or other reason validation could not be determined, for example, within a threshold of time, then the WTRU Configuration Update message to the WTRU may indicate that the system feature is still pending validation. The indication that the system feature is still pending validation indicates to the WTRU that validation for the system feature is indeterminate and/or the UCV Server was not reached. In some embodiments, such an indication can be used by the WTRU to trigger a new registration validation procedure and provide a different UCV Server Identifier to the AMF.

In some embodiments, the UCV Server may optionally indicate system features to the AMF that were validated but not requested by the WTRU. The WTRU Configuration Update procedure may then indicate to the WTRU that these system features, which were not requested by the WTRU, were validated. The WTRU may then know that those system features can be used without re-attempting validation.

If the WTRU receives a Configuration Update message with an indication that a system feature was not validated, the WTRU may display a message to a user that indicates that the system feature cannot used because the system feature was not validated. In this case, the WTRU may display the message immediately upon receiving the WTRU Configuration Update message or when the user attempts to perform an operation that requires the system feature.

When the WTRU's support for the system feature was not validated, the AMF may indicate, in the WTRU Configuration Update message, that the WTRU is not permitted to request to use the feature again until after a WTRU de-registration event. The AMF may later receive a notification from the UDM/UDR that the WTRU's support for the feature has been validated (e.g., after a WTRU software upgrade). The notification from the UDM/UDR may trigger the AMF to send a WTRU Configuration Update message to the WTRU to remove the restriction that the WTRU is not permitted to request to use the feature again until after a WTRU de-registration event.

Embodiments for System Feature Validation in the Application Layer are now described. As discussed previously in respect to FIG. 3, upon sending a Registration Response in step 308, in these embodiments, the AMF may further send a system feature validation trigger to the WTRU to initiate an application layer procedure to validate a system feature. In other words, sending a Registration Response that indicates that the WTRU may only use the system feature on the condition the WTRU's support for the system feature has been validated, may cause the AMF to trigger the WTRU to initiate an application layer procedure to validate a system feature.

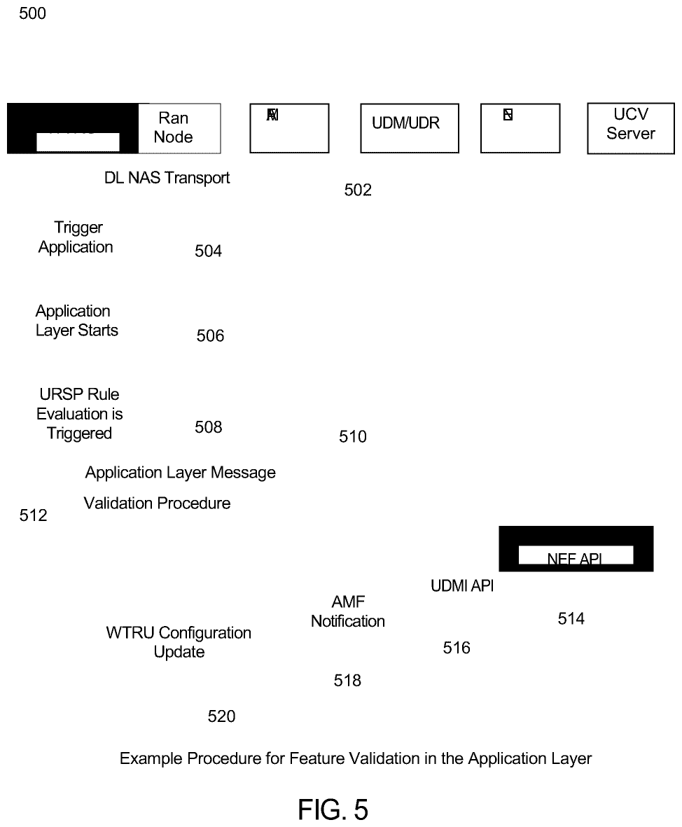

Referring to FIG. 5, an example method 500 is shown where the WTRU establishes a PDU Session and uses the PDU Session to perform a validation procedure with a UCV Server over the user plane (i.e. application layer).

In method 500, the AMF sends 502 a DL NAS Transport Message to the WTRU. In these embodiments, the DL NAS Transport Message may include an identity of a UCV Server (e.g., FQDN or IP Address) and the GPSI of the WTRU. The system feature validation trigger message may optionally indicate which system feature(s) the WTRU is expected to verify/validate. Optionally, in some embodiments, step 502 may be combined with step 308 in FIG. 3. In other words, the identity of a UCV Server for use in a system feature validation procedure by the WTRU may be sent in the Registration Response from the AMF. The trigger for this step may be after a Registration Request is received from the WTRU and the AMF detects that a WTRU's support for a system feature needs to be validated (e.g. as described in reference to FIG. 3).

According to one example, the WTRU may have been previously configured with a user equipment route selection policy (URSP) Rule. In an example, the UCV Server Address may be in the Traffic Descriptor of the URSP Rule and one of the route descriptors of the URSP Rule may include a data network name (DNN) and single network slice selection assistance information (S-NSSAI) combination.

The reception by the WTRU of the DNL NAS Transport Message 502 (i.e., system feature validation trigger message) indicates that the WTRU needs to verify a system feature is validated for use. This may trigger 504 the WTRU to send the identity of the UCV Server and GPSI to a WTRU Application. For example, this information may be sent from the mobile termination (MT) part of the WTRU to a WTRU Application in the terminal equipment (TE) part within the WTRU.

The application layer starts in step 506 and in step 508, the WTRU may perform URSP Rule evaluation and the URSP Rule may trigger the WTRU to send a PDU Session Establishment request to the DNN and S-NSSAI combination in the route selection descriptor (RSD) part of the URSP Rule. The WTRU and network may complete the PDU Session Establishment procedure.

In step 510, the WTRU may send the application layer message to the address of the UCV Server. The message initiates a system feature validation procedure with the UCV Server, represented by step 512. In this procedure the UCV Server may authenticate an identity of the WTRU (e.g. using the PEI) and verify what software images are installed in the WTRU. In some cases, the UCV Server may trigger the WTRU to perform a software update procedure in order to ensure that the WTRU properly supports certain system features. The WTRU Application may send the GPSI of the WTRU to the UCV Server.

Once the application layer authentication procedure is complete, the UCV Server may send 514 a message to the 5GC, e.g., the network exposure function (NEF), to indicate what system feature(s) have been validated for the WTRU. The message 514 from the UCV Server may indicate the system feature(s) that have been validated and may include the GPSI of the WTRU.

The NEF stores the information from the UCV Server in the WTRU's subscription that indicates which system features have been validated for the WTRU and updating UDM/UDR at step 516. The information from the UCV Server may indicate that the UCV Server, or another service provider, is willing to sponsor the WTRU's use of the system feature(s) and the UDM/UDR may store this sponsorship indication in a charging data record (CDR).

In this example, the UDM/UDR sends 518 a notification to the AMF that the WTRU's subscription has been updated with information that indicates which system features have been validated for the WTRU. Lastly, the AMF sends 520 a WTRU Configuration Update message to the WTRU.

If the message 518 from the UDM/UDR indicated the system feature was validated, then the WTRU Configuration Update message 520 indicates that the system feature was validated and indicates to the WTRU that the system feature can be used by the WTRU.

If the validation result from the UCV Server indicated the system feature was NOT validated, then the WTRU Configuration Update message 520 from the AMF indicates that the system feature was NOT validated, which informs the WTRU that the system feature cannot be used by the WTRU.

In some embodiments, the UCV Server may optionally indicate system features were validated but not requested by the WTRU. In this case, the WTRU Configuration Update procedure may then indicate to the WTRU that these system features, which were not requested by the WTRU, were validated. The WTRU may then know that those system features can be used without (re) attempting validation.

Similar to previous embodiments, if the WTRU receives an indication that a system feature was not validated, the WTRU may display a message to a user that indicates that the system feature cannot be used because the system feature was not validated. The WTRU may display the message immediately upon receiving the WTRU Configuration Update message or when the user attempts to perform an operation that requires the system feature which was not validated.

In some embodiments, when the WTRU's support for the system feature was not validated, the AMF may indicate, in the WTRU Configuration Update message, that the WTRU is not permitted to request to use the system feature again until after a WTRU de-registration event. The AMF may later receive a notification from the UCV Server that the WTRU's support for the feature has been validated (e.g. after a WTRU software upgrade). This notification from the UDM/UDR may trigger the AMF to send a WTRU Configuration Update message to the WTRU to remove the restriction that the WTRU is not permitted to request to use the feature again until after a WTRU de-registration event and/or enable the WTRU use of the system feature.

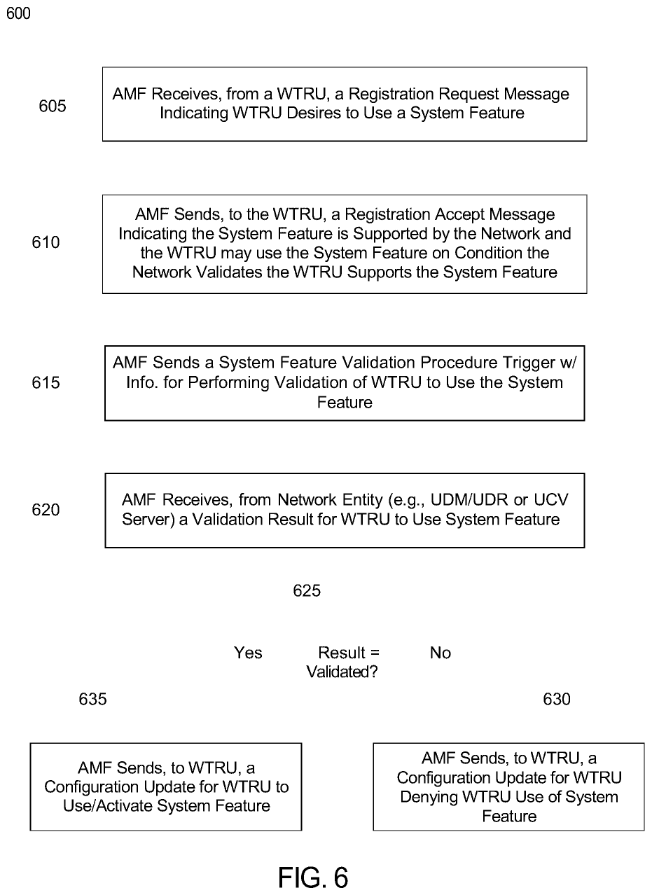

Referring to FIG. 6, an example method 600 for an access and mobility management function (AMF) performing validation of system features is shown. Method 600 may begin by the AMF receiving 605, from a wireless transmit receive unit (WTRU), a Registration Request message indicating the WTRU intends or desires to use a system feature of the network. The AMF sends 610, to the WTRU, a Registration Accept message indicating the system feature is supported by the network and that the WTRU may access the feature on a condition that the network validates the WTRU supports the system feature. The AMF sends 615, to the WTRU, a system feature validation trigger message. The Registration Accept and/or the system feature validation trigger message may be sent in a DL NAS message. As mentioned previously, the system feature validation trigger message may be combined/included with the Registration Accept message in which steps 610 and 615 are combined or the AMF may send 615 a subsequent separate system feature validation trigger message including information for the WTRU to perform a system feature validation procedure with a different entity such as a UCV Server as described in previous embodiments.

Next, the AMF receives 620, from a network entity (e.g., UDM/UDR or UCV Server), a validation result message associated with the system feature validation trigger message sent to the WTRU. The validation result message indicates whether the WTRU is validated or not validated to use the system feature requested by the WTRU (and possibly validation of other system feature(s) not specifically requested by the WTRU as described previously). If 625, the received validation result message indicates that the WTRU is NOT validated, the AMF sends 630 a Configuration Update message to the WTRU indicating the WTRU is not allowed, i.e., denied, use of the requested system feature and optionally, the WTRU may not request use of the system feature as described previously. If 625, the received validation result message indicates that the WTRU is validated for use of the system feature, the AMF sends 635 a Configuration Update message to the WTRU indicating the WTRU is validated to use/activate the requested system feature.

In some embodiments, the system feature validation trigger message includes information for performing the validation procedure by the WTRU including an extensible authentication protocol (EAP) identity request as described previously in respect to FIG. 4. In other embodiments, the system feature validation trigger message includes information for performing the validation procedure comprises an identify of a user equipment certification validation (UCV) server and a generic public subscription identifier (GPSI) of the WTRU as described previously in respect to FIG. 5.

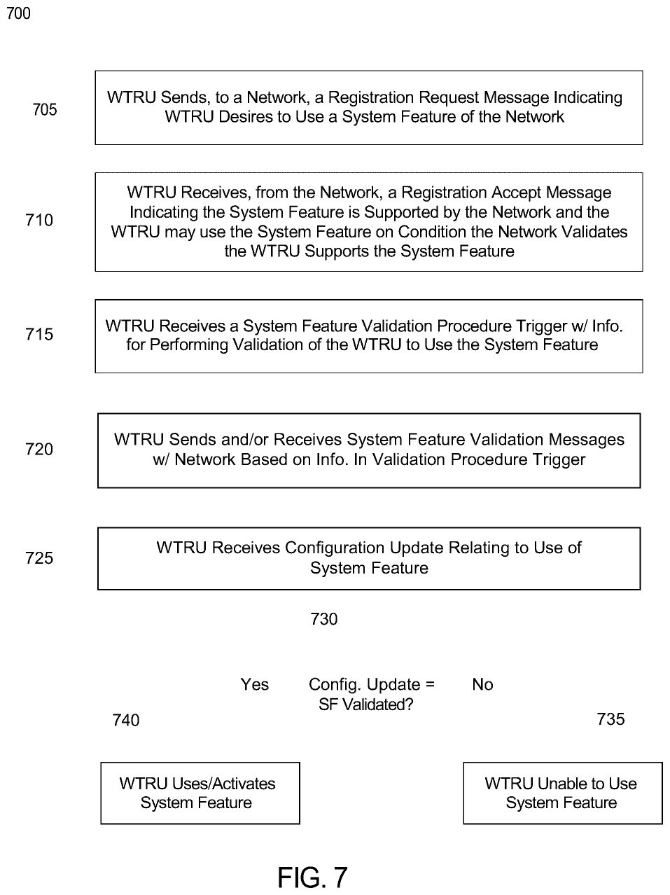

Referring to FIG. 7, an example method 700 for a WTRU performing validation of system features is shown. Initially, the WTRU sends 705, to a network, e.g., an AMF, a Registration Request message indicating the WTRU intends or desires to use a system feature of the network. The WTRU receives 710, from the network, a Registration Accept message indicating the system feature is supported by the network and that the WTRU may use the feature on a condition the network validates the WTRU supports the system feature. The WTRU receives 715, from the network, a system feature validation trigger with information for performing a validation procedure for the WTRU to use the system feature. As mentioned previously, this trigger may be a separate message from the AMF or included as part the Registration Accept message.

The WTRU sends to 720, and depending on the embodiment, receives from, a network entity, e.g., a UCV Server, system feature validation message(s) based on the information for performing the validation procedure in the system feature validation trigger from the AMF. Next, the WTRU receives 725 a Configuration Update from the AMF. If 730, the Configuration Update indicates the system feature is NOT validated, the WTRU determines 735 it is unable to use the system feature, and optionally unable to request registration for the user feature again, as described previously. If 730, the Configuration Update indicates the system feature is validated for use, the WTRU determines 740 it may use/activate use of the validated system feature.

In one embodiment, the system feature validation trigger includes information for performing the validation procedure including an extensible authentication protocol (EAP) identity request. In another embodiment, the system feature validation trigger includes information for performing the validation procedure including one or more identities of UCV Server and a generic public subscription identifier (GPSI) of the WTRU.

Examples of system features which may be requested for validation will now be described.

Session Management Features. Session and service continuity (SSC) modes in the 5GS enable addressing various continuity requirements of different applications and services for WTRUs. SSC modes are system features that relate to a PDU Session and are therefore a session management feature for a session management function (SMF). Support of specific types of SSC Modes are examples of a system feature that may need to be validated. For example, the network may need to obtain validation that a WTRU supports SSC Mode 1, SSC Mode 2, or SSC Mode 3.

When the method 300 of FIG. 3 is executed, the system feature may be support of SSC Mode 1, SSC Mode 2, or SSC Mode 3. For example, in the Registration Response of step 308 in FIG. 3, the WTRU may receive an indication that the WTRU may not use SSC Mode 1, may not use SSC Mode 2, or may not use SSC Mode 3 until the network validates that the WTRU supports the system feature(s).

The example procedures shown in FIG. 4 or FIG. 5 may be performed to validate that the WTRU supports SSC Mode 1, SSC Mode 2, or SSC Mode 3. The network (i.e. AMF and/or UDM/UDR) may store the validation results for the WTRU's support of SSC Mode 1, SSC Mode 2, and/or SSC Mode 3.

Subsequently, the WTRU may send a PDU Session Establishment request to the network. The PDU Session Establishment request message may indicate that the WTRU requests to use SSC Mode 1, SSC Mode 2, or SSC Mode 3 for the PDU Session. When the AMF forwards the PDU Session Establishment request to the SMF, the AMF may also indicate to the SMF which SSC Mode(s) have been validated for the WTRU. The SMF may use the WTRU's validated SSC Modes and requested SSC Mode to determine whether to establish the PDU Session and what SSC Mode to assign to the PDU Session if the SMF determines to establish the PDU Session.

For example, the SMF may compare the SSC Mode requested by the WTRU in the PDU Session Establishment request to the SSC Mode(s) that the AMF indicated where validated for use by the WTRU.

If the SSC Mode that was requested by the WTRU was validated (i.e. the network validated that the WTRU supports the SSC Mode), the SMF may send a PDU Session Establishment accept message and the PDU Session Establishment accept message may indicate that the SSC Mode of the PDU Session is the same value that was received in the PDU Session Establishment request message.

If the SSC Mode that was requested by the WTRU was NOT validated (i.e. the network has not validated that the WTRU supports the requested SSC Mode), the SMF may send a PDU Session Establishment accept message indicating that the SSC Mode of the PDU Session is DIFFERENT than was received in the PDU Session Establishment request message. For example, the WTRU may have requested to use SSC Mode 3, but the network may indicate that SSC Mode 1 will be used since the WTRU's support of SSC Mode 3 has not been validated.

Alternatively, if the SSC Mode that was requested by the WTRU was NOT validated (i.e. the network has not validated that the WTRU supports the requested SSC Mode), the SMF may send a PDU Session Establishment reject message including a cause code that indicates that that the establishment of the PDU Session was rejected because the WTRU's support for the requests SSC mode has not been validated. For example, the WTRU may have requested to use SSC Mode 3, but the network has not validated that the WTRU supports SSC Mode 3, so the PDU Session is rejected by the SMF.

The foregoing describes an example scenario where a WTRU requests to use a system feature related to a PDU Session and the SMF sends a rejection message to the WTRU that indicates that the feature cannot be used because the network has not validated the WTRU's support for the feature. As described in the procedures of FIG. 4-7, the network may inform the WTRU if some system features have been validated or not. However, in alternative embodiments, the WTRU may assume that a system feature does not need to be validated until the network sends a message to the WTRU after the WTRU attempts to activate the system feature. For example, a message from the network may reject the WTRU's attempt to activate a system feature and indicate to the WTRU that the WTRU may not use the feature until the system feature's use by the WTRU has been validated. In this case, the rejection message may trigger the WTRU to start the system feature validation procedure, for example, in FIG. 4 from step 404 or in FIG. 5, to start the procedure from step 504.

SSC Mode is one example of a system feature where the SMF may be requested to configure an SSC Mode of one value in a PDU Session Establishment request and the SMF may choose to configure an SSC Mode of another value for the PDU Session Establishment accept. However, there are other session management features for which it may not be acceptable for the SMF to change the value requested. For example, the WTRU may request to establish a PDU Session of a certain Type (e.g., IPV4, IPV6, IPV4 and IPV6, Unstructured, or Ethernet) and the SMF may detect that the that the requested PDU Session Type has not been validated for the WTRU. The SMF may reject the establishment of the PDU Session and indicate that the WTRU's support for the PDU Session Type has not been validated. In this, or similar cases, the PDU Session Establishment rejecting message may trigger the system feature validation procedure for the WTRU, e.g., in FIG. 4 from step 404, or in FIG. 5 from step 504.

Similar to the PDU Session Type feature, there are other session management features that the SMF may reject with a cause code that indicates that the feature has not been validated for the requesting WTRU. Another example system feature the SMF may reject with a cause code that indicates that the feature has not been validated, is the use of header compression for Control Plane cellular Internet of Things (CIoT) 5GS optimization. Yet another system feature the SMF may reject with a cause code that indicates that the feature has not been validated for the requesting WTRU, is the use Reflective quality of service (QoS). Other examples of features that the SMF may reject with a cause code that indicates that the feature has not been validated for the requesting WTRU may include support of Multi-homed IPV6 PDU session, support of access traffic steering, switching and splitting (ATSSS) steering functionalities and steering modes, support of transferring port management information containers, support of access performance measurements per QoS flow, and support of Secondary DN authentication and authorization over evolved packet core (EPC).

The WTRU Integrity Protection Maximum Data Rate is an example of a feature where the SMF may request to configure a WTRU Integrity Protection Maximum Data Rate of one value in a PDU Session and the SMF may choose to configure a WTRU Integrity Protection Maximum Data Rate of another value for the PDU Session. The SMF may reject the establishment of the PDU Session and indicate that the WTRU's support for the WTRU Integrity Protection Maximum Data Rate has not been validated for the requesting WTRU. The PDU Session rejecting message may trigger the procedure of FIG. 4 from step 404 or the procedure of FIG. 5 from step 504. In one example, the PDU Session rejection may indicate a WTRU Integrity Protection Maximum Data Rate value that has been validated for the requesting WTRU.

As described above, the AMF may indicate to the SMF which system features have been validated for the WTRU (e.g. which SSC Modes). The AMF may also indicate which WTRU Integrity Protection Maximum Data Rate values have been validated for the WTRU and/or which PDU Session Type values have been validated for the WTRU. The SMF may receive the information about which system features have been validated when it receives the PDU Session Establishment request.

When the WTRU receives a NAS-session management (SM) message (e.g. a PDU Session Establishment reject message) that indicates that a requested system feature has not been validated, the MT part of WTRU may send a message to the TE part of the WTRU to indicate that the indicated system feature has not been validated. In an example, an application in the TE part of the WTRU (e.g. a GUI) may display a message that indicates that the system feature has not been validated and may display information about the version of software that is currently installed in the WTRU and/or may recommend that a software update be initiated.

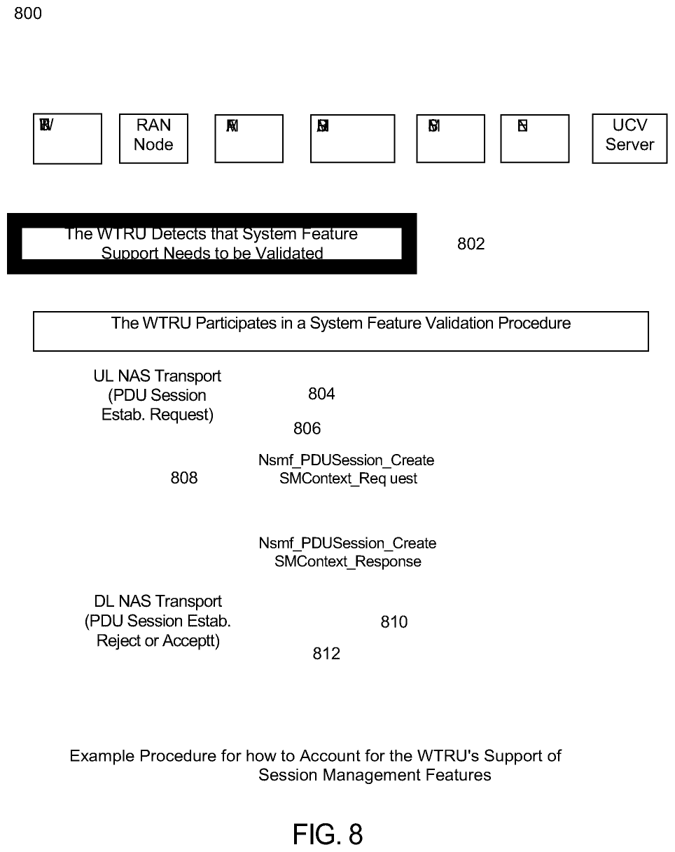

Referring to FIG. 8, an example method 800 is shown for how the network may account for whether the WTRU's support for a requested session management feature is validated or is not validated. In method 800, the WTRU may detect 802 that the WTRU's support for certain system features (e.g., session management features) needs to be validated. FIG. 3 shows an example method 300 for how the WTRU may detect that the WTRU's support for certain system features may need to be validated in step 802 of FIG. 8, although the embodiments are not limited in this respect.

In method 800 at step 804, the WTRU and network may perform a procedure to validate WTRU's support of certain system features (e.g. session management features). FIGS. 4-7 show example procedures for how the WTRU and network may perform a procedure to validate the WTRU's support of certain system features, although the embodiments are not limited in this respect.

In step 804, the WTRU may send 806 an UL NAS Transport message to the network carrying a PDU Session Establishment request. In this step, the WTRU requests that the PDU Session be configured with a certain system feature such as an SSC Mode value, PDU Session Type value, WTRU Integrity Protection Maximum Data Rate value, and/or support for header compression for Control Plane CIoT 5GS optimization.

In step 808, the AMF invokes the SMF's Nsmf_PDUSession_CreateSMContext_Request service operation. In this step the AMF forwards the WTRU's PDU Session Establishment request to the SMF. In this step the SMF receives an indication that the WTRU requests that the PDU Session Establishment request be configured with a certain system feature, for example, a SSC Mode value, PDU Session Type value, WTRU Integrity Protection Maximum Data Rate value, support for header compression for Control Plane CIoT 5GS optimization, etc. The AMF may also provide the SMF with information about which system features have been validated for the WTRU, if not already known to the SMF based on the system feature validation procedure in step 804.

As described above, the SMF uses the information about which system features have been validated for the WTRU to determine whether to accept or reject the request to establish a PDU Session. Alternatively, also as described above, the SMF may use the information about which system features are requested/validated to determine how to configure the PDU Session. For example, the SMF may decide to configure the PDU Session in a way that is different than what was requested by the PDU Session (e.g. may change the SSC Mode). Next, the SMF will send 810 a Nsmf_PDUSession_CreateSMContext_Response message to the AMF. The response message from the SMF carries a PDU Session Establishment Accept or a PDU Session Establishment Reject message. Lastly, the AMF sends 812 a DL NAS Transport message to the WTRU. The DL NAS Transport message carries the PDU Session Establishment Accept or a PDU Session Establishment Reject message to the WTRU.

Mobility Management Features. Network Slicing is an example of a Mobility Management feature and WTRU support of Network Slicing is an example of a system feature that may need to be validated. For example, the network may need to obtain validation that the WTRU supports network slicing or registering to a number of network slices.

When the example procedure for detecting that a system feature requires validation of FIG. 3 is executed, the system feature may be support of network slicing or the ability of to register to a certain number of network slices. For example, in the Registration Response of step 308 of FIG. 3, the WTRU may receive an indication that the WTRU may not request to register to a network slice until the network validates that the WTRU supports the feature. In one example, the WTRU may still be allowed to send a PDU Session Establishment Request to the network, but the WTRU may not be allowed to include a S-NSSAI in the PDU Session Establishment request, if the WTRU has not been validated to support this feature. In one example, the network may associate all of the WTRU's PDU Sessions with a default network slice (i.e. S-NSSAI) which is obtained from the WTRU's subscription information from the UDM/UDR. One of the example procedures of FIG. 4-7 may be performed to validate that the WTRU supports network slicing, although the embodiments are not limited in this respect.

In this example, the network (i.e. AMF or UDM/UDR) may store the validation results for the WTRU's support of network slicing. The system feature validation results may indicate whether the WTRU's support of network slicing has been validated and/or may indicate a limit on many network slices for which the WTRU may register. Subsequently, the WTRU may send a Registration Request to the network that indicates the WTRU requests to register to a network slice. The network slice (i.e. S-NSSAI) may be identified in a Requested NSSAI information element of the Registration Request.

If the WTRU's support of network slicing has been validated by the network, then the network may accept the WTRU's request to register to the network slice and the AMF may send a Registration Accept message to the WTRU and the requested slice may be included in an Accepted NSSAI information element of the Registration Accept message.

If the WTRU's support of network slicing has NOT been validated by the network, then the network may accept the WTRU's request to register with the network but reject the WTRU's request to register to the network slice. In this case, the AMF may send a Registration Accept message to the WTRU and the requested slice may be included in a Rejected S-NSSAI information element of the Registration Accept message. The rejection cause code for the Rejected S-NSSAI may indicate that the WTRU's support of network slicing has not been validated. The WTRU may then only send Registration Request messages to the network that include no Requested NSSAI and the network may only register the WTRU to a default slice that is identified in the WTRU's subscription information in the UDM/UDR. Alternatively, the rejection cause code for the Rejected S-NSSAI may indicate that registration to the network slice was rejected because the WTRU is limited to the registering to a certain number of network slices and the WTRU is already registered to its limit.

In one example, if the WTRU's support of network slicing has NOT been validated by the network, then the network may reject the WTRU's request to register with the network. The rejection cause code for the Registration Reject message may indicate that the WTRU's support of network slicing has not been validated. The WTRU may then only send Registration Request messages to the network that include no Requested NSSAI and the network may only register the WTRU to a default slice that is identified in the WTRU's subscription information in the UDM/UDR.

The AMF may send a message to the RAN Node connecting the WTRU, indicating that the WTRU is not allowed to use the network slicing feature. The RAN Node may use this information to reject any RRC message that is sent from the WTRU that includes an S-NSSAI or any RRC message that is sent from the WTRU after the WTRU uses slice specific RACH resources (i.e. RACH resources that are associated with the S-NSSAI).

Example scenarios are now described where a WTRU requests to use a mobility management-related system feature and the SMF sends a rejection message to the WTRU that indicates that the feature cannot be used because the network has not validated the WTRU's support for the requested feature. As described in the example procedures of FIGS. 4 and 5, the network may inform the WTRU if some system features have been validated or not. However, in alternative embodiments, the WTRU may assume that a system feature does not need to be validated until the network sends a message to the WTRU after the WTRU attempts to active the system feature. For example, a message from the network may reject the WTRU's activation of the system feature and indicate to the WTRU that the WTRU may not use the feature until the WTRU's support for the feature has been validated by the network. In these embodiments, the rejection message may trigger the WTRU to start the system feature validation procedure, for example in FIG. 4 from step 404, or in FIG. 5, to start the procedure from step 504.

Network slicing is one example of a system feature that the WTRU may attempt to access, or configure, in a registration procedure and the network may reject, because the WTRU's support of the system feature has not been validated. When the WTRU sends a Registration Request to the network, the WTRU may indicate that it supports, or would like to use, certain system features. Additional example system features which may be desirable or require validation of a WTRU's support for the feature may include: support of EPC NAS, support of LTE Positioning Protocol, support of restricting the use of enhanced coverage, support of sending data over the control plane (i.e. NAS), support of IP header compression when sending data over the control plane, support of service gap control, support of vehicle-to-everything (V2X) communication procedures, support of 5G location service (LCS) notification mechanisms, support of Network slice-specific authentication and authorization, support of radio capability signaling (RACS), support of closed access group (CAG), support for receiving wake-up signal (WUS) assistance information, support of Ethernet header compression, support of proximity services (ProSe) communication procedures, support for certain types of paging procedures, support for Network Slice Simultaneous Group (NSSRG) procedures, support for Minimization of Service Interruption (MINT) procedures, support for Steering of Roaming procedures, support for Network Slice AS Group (NSAG) procedures, support for Uncrewed Arial System (UAS) procedures, support for IP Multimedia Subsystem (IMS), and support for network slice replacement procedures.

The network may respond to the WTRU's Registration Request message with a Registration Accept message that indicates that one or more of the features that were requested by the WTRU may not be used by the WTRU because the WTRU's support of the requested feature has not been validated. Alternatively, the network may respond to the WTRU's Registration Request with a Registration Reject message and the rejection cause code of the Registration Reject message may indicate that one or more of the features that were requested by the WTRU may not be used by the WTRU because the WTRU's support of the requested feature has not been validated. If the registration is rejected, the WTRU may attempt to register again but may not indicate that it requests access to the rejected feature until the WTRU receives an indication that the WTRU's support of the feature has been validated. In one example, if the registration is accepted, the WTRU may not attempt to use the feature until the WTRU receives an indication that the WTRU's support of the feature has been validated.

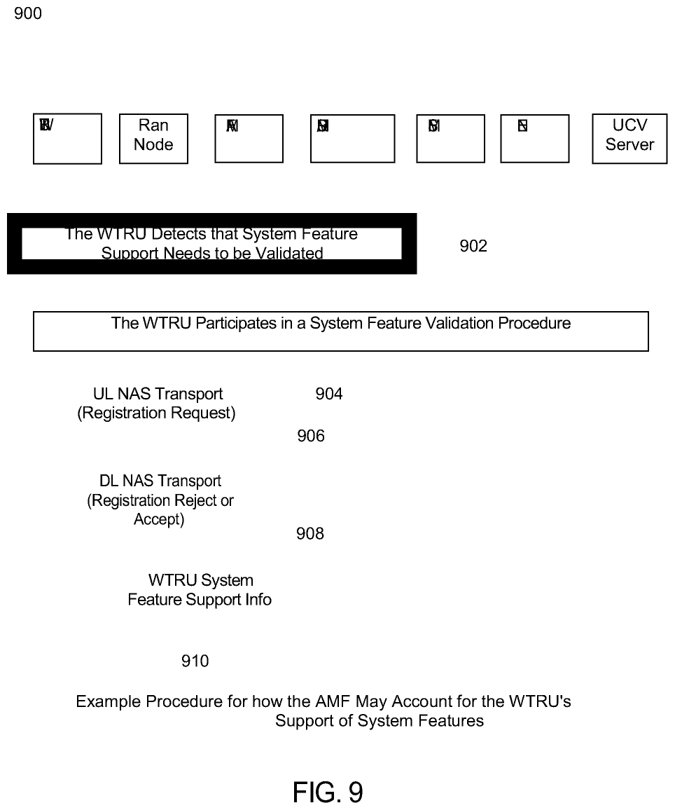

Referring to FIG. 9, an example method 900 is shown for a network node, e.g., the AMF, handling whether the WTRU's support for a system feature is validated or is not validated. In method 900, the WTRU may detect 902 that the WTRU's support for certain system features (e.g. mobility management features) needs to be validated. Step 902 may be similar to the detection discussed in reference to FIG. 3 example procedure 300, although this embodiment is not limited in this respect.

Next, the WTRU and network may perform 904 a procedure to validate the WTRU's support of certain system features (e.g. session management features). Step 904 may be similar to validation procedures discussed in reference to FIG. 4, method 400 or FIG. 5, method 500 example procedures for the WTRU and network performing a procedure to validate the WTRU's support of certain system features, although this embodiment is not limited to validation with those procedures.

The WTRU next sends 906 an UL NAS Transport message to the network, e.g., a Registration Request in which the WTRU requests to use a system feature or permission to use a system feature, e.g., network slicing, ATSSS, or any of the previously-described example system features. As in previous embodiments, the AMF uses the information about which system features have been validated for the WTRU, e.g., determined from step 904 or previously stored, to determine whether to accept or reject the request to activate the system feature or a request for permission to use a system feature, and the AMF sends 908 a DL NAS Transport message indicating Registration Accept or Registration Reject to the WTRU.

In these embodiments, a distinction may be made between requesting activating a system feature and requesting permission to use a system feature as follows. An example of activating a system feature is where the WTRU attempts to use the registration to begin using the system feature immediately. For example, the Registration Request in step 906 may include a request to register to a network slice. An example of requesting permission to use a system feature is where the WTRU indicates in the registration that it supports the system feature and may attempt to use or activate the system feature in a future procedure. For example, the Registration Request in step 906 may include a request for permission to use the ATSSS feature and, if permission is received, the WTRU may attempt to activate the feature in a subsequent PDU Session Establishment procedure (not shown).

In method 900, the AMF may send 910 a message to the RAN Node, connecting the WTRU, that indicates which system features the WTRU is allowed to activate (i.e. which system features have been validated for the WTRU).

In some examples, the messages of steps 908 and 910 may be combined. In other words, the content of the message of step 908 and the content of the message of step 910 may be sent to the RAN Node in a single message. Alternatively, the message of step 910 may be sent to the RAN Node before the message of step 908 is sent to the WTRU.

Additional system feature validation triggers are now described. Once a system feature is validated for a given WTRU, it may be inefficient to repeat the validation procedure and/or even triggering the procedure every time the WTRU performs an initial registration may be inefficient. As described above, the AMF may store information in the WTRU's context or subscription information about which system features were validated.

In some embodiments, the network may detect certain events and trigger the validation procedure based on the detection of the event. Detection of such events and repeating the validation procedure may help in detecting that the subscription identifier is being used by a different WTRU and detecting that the WTRU no longer supports the feature (e.g. because the software that runs on the WTRU has changed).

Analytics-based triggers may be used for system feature validation. In one example, the AMF may configure the network data analytics function (NWDAF) to monitor the WTRU's behavior related to the system features that have been validated for the WTRU. For example, the AMF may invoke a service of the NWDAF that requests the NWDAF to monitor WTRU behavior and the request may indicate the system feature that should be monitored. In an example the system feature is used within a network slice or PDU Session, then the request may indicate the PDU Session ID, S-NSSAI and NS ID. Examples of system features that are used within a PDU Session or network slice are Reflective QoS, non-IP data delivery, SSC Modes, Ethernet PDU Session Types, IP PDU Session Types, and non-IP PDU Session Types. Connecting to the network a reduced capability (REDCAP) device is an example of a system feature that is not used within a network slice or PDU Session.

The NWDAF may monitor WTRU behavior and, based on the monitored WTRU behavior, the NWDAF may send an indication to the AMF that validation of the system feature should be performed. For example, the NWDAF may monitor WTRU traffic reports from the user plane function (UPF) and observe that the WTRU sent data at a rate that is greater than what a REDCAP WTRU should send. The NWDAF may then send a notification to the AMF that the WTRU's support for the REDCAP system feature should be (re) validated. When the AMF receives an indication from the NWDAF that a system feature should be (re) validated, the AMF may trigger the system feature validation procedure, e.g., procedures of FIG. 4 or FIG. 5.

Event-based triggers may be used for system feature validation. In one example, the AMF may decide to trigger the validation procedure, e.g., of FIG. 4 or 5, when the WTRU moves to the AMF from an AMF of another network. In other words, the system validation procedure may be triggered when the AMF that serves the WTRU changes (i.e. when the WTRU's serving network changes).

Artificial intelligence machine learning (AI/ML) capabilities may also be considered in system feature validation. In an example, the NEF may receive a request from an application function (AF) for assistance in a Member WTRU selection procedure. Certain procedures can be used to enhance the assistance information that is provided by the NEF. For example, the NEF may trigger a system feature validation procedure, e.g., of FIG. 4 or 5, in order to verify the WTRU's AI/ML capabilities. In one embodiment, the NEF may trigger the system feature validation procedure by sending a request message to the UDM/UDR. The UDM/UDR may then request that the AMF that serves the WTRU, to trigger the validation procedure. The NEF may receive a notification message from the UDM/UDR about the WTRU's level of support for AI/ML operations. The NEF may then use the information about the WTRU's level of support for AI/ML operations to determine which WTRU's to include in the candidate list of WTRU(s) that is sent to the AF.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for an access and mobility management function (AMF), the method comprising:
receiving, from a wireless transmit receive unit (WTRU), a registration request message indicating the WTRU intends to use a system feature;
sending, to the WTRU, a registration accept message indicating the system feature is supported by a network and the WTRU may use the system feature on a condition the network validates the WTRU supports the system feature;
sending, to the WTRU, a system feature validation trigger;
receiving, from a network entity, a validation result message associated with the system feature validation trigger, the validation result message indicating the WTRU is validated or not validated to use the system feature; and
sending, to the WTRU, a configuration update message based on the received validation result message.

2. The method of claim 1, wherein the system feature validation trigger comprises a downlink (DL) non-access stratum (NAS) message including information for performing a validation procedure for the WTRU to use the system feature.

3. The method of claim 2, wherein the information for performing the validation procedure comprises an extensible authentication protocol (EAP) identity request.

4. The method of claim 2, wherein the information for performing the validation procedure comprises an identity of a user equipment certification validation (UCV) server and a generic public subscription identifier (GPSI) of the WTRU.

5. The method of claim 1, wherein the network entity comprises a unified data management (UDM) or a unified data repository (UDR) database.

6. The method of claim 1, wherein the network entity comprises a user equipment certification validation (UCV) server.

7. A network node including an access and mobility management function (AMF), the network node comprising:
a transceiver and a processor operatively coupled to the transceiver, the transceiver and processor configured to:
receive, from a wireless transmit receive unit (WTRU), a registration request message indicating the WTRU intends to use a system feature;
send, to the WTRU, a registration accept message indicating the system feature is supported by a network on a condition the network validates the WTRU supports the system feature;
send, to the WTRU, a system feature validation trigger;
receive, from a network entity, a validation result message associated with the system feature validation trigger, the validation result message indicating the WTRU is validated or not validated to use the system feature; and
send, to the WTRU, a configuration update message based on the received validation result message.

8. The network node of claim 7, wherein the system feature validation trigger comprises a downlink (DL) non-access stratum (NAS) message including information for performing a validation procedure for the WTRU to use the system feature.

9. The network node of claim 8, wherein the information for performing the validation procedure comprises an extensible authentication protocol (EAP) identity request.

10. The network node of claim 8, wherein the information for performing the validation procedure comprises an identity of a user equipment certification validation (UCV) server and a generic public subscription identifier (GPSI) of the WTRU.

11. The network node of claim 7, wherein the network entity comprises a unified data management (UDM) or a unified data repository (UDR) database.

12. The network node of claim 7, wherein the network entity comprises a user equipment certification validation (UCV) server.

13. A method implemented in a wireless transmit receive unit (WTRU), the method comprising:
sending, to a network, a registration request message indicating the WTRU intends to use a system feature;
receiving, from the network, a registration accept message indicating the system feature is supported by the network and that the system feature may be used by the WTRU on a condition the network validates the WTRU supports the system feature;
receiving, from the network, a system feature validation trigger;
sending to, the network, a system feature validation message based on the system feature validation trigger; and
receiving, from the network, a configuration update message indicating the WTRU may or may not use the system feature.

14. The method of claim 13, wherein the system feature validation trigger comprises a downlink (DL) non-access stratum (NAS) message including information for performing a validation procedure for the WTRU to use the system feature.

15. The method of claim 14, wherein the information for performing the validation procedure comprises an extensible authentication protocol (EAP) identity request.

16. The method of claim 14, wherein the information for performing the validation procedure comprises an identity of a user equipment certification validation (UCV) server and a generic public subscription identifier (GPSI) of the WTRU.
